(19) United States
(12) Patent Application Publication
(10) Pub. No.: US 2022/0013841 A1
(43) Pub. Date: Jan. 13, 2022

(54) ELECTRICITY STORAGE BATTERY AND MANUFACTURING METHOD OF SAID BATTERY

(71) Applicant: Faurecia Systemes D'Echappement, Nanterre (FR)

(72) Inventors: Frédéric Greber, Ecot (FR); Quentin Provost, Cravanche (FR); Nicolas Husy, Montbeliard (FR); Thomas Beaurenaut, Luxeuil Les Bains (FR); Jaouad El Harfi, Belfort (FR)

(21) Appl. No.: 17/371,994

(22) Filed: Jul. 9, 2021

(30) Foreign Application Priority Data
Jul. 10, 2020 (FR) 2007331

(51) Int. Cl. H01M 50/227; H01M 50/209; H01M 50/242; H01M 50/249; H01M 10/613; H01M 10/6568; H01M 10/6556; H01M 10/625; H01M 10/647; B29C 39/02; B29C 39/10

(52) U.S. Cl. CPC H01M 50/227; H01M 50/209; H01M 50/242; H01M 50/249; H01M 10/613; H01M 10/6568; B29L 2031/7146; H01M 10/625; H01M 10/647; B29C 39/026; B29C 39/10; H01M 2220/20; H01M 10/6556

(57) ABSTRACT

A battery comprises beams dividing a cell module receiving volume into a plurality of compartments and a low-density plastic material. The low-density plastic material comprises an upper part over-molded onto the beams. Each compartment is delimited by an inner surface at least partially defined by the upper part of the low-density plastic material.

### CROSS REFERENCE TO RELATED APPLICATIONS

This application claims priority o and the benefit of French Patent Application Number 2007331, filed 10 Jul. 2020, the disclosure of which is now expressly incorporated herein by reference.

### FIELD OF THE DISCLOSURE

The present disclosure relates to electricity storage batteries in general, particularly for motor vehicles.

### BACKGROUND

It is possible to equip motor vehicles with electric batteries containing a large number of electricity storage cells.

### SUMMARY

The present disclosure aims to provide an electricity storage battery in which the integration of low-density plastic parts is facilitated. According to one aspect of the disclosure, an electricity storage battery includes a plurality of modules, each module comprising a plurality of electricity storage cells; a casing internally delimiting a volume for receiving the modules, the casing comprising a lower part and a cover; beams integral with the casing and dividing the receiving volume into a plurality of compartments, each module being received in one of the compartments; and a low-density plastic material comprising an upper part over-molded on the beams. Each compartment may be delimited by an internal surface at least partially defined by the upper part of the low-density plastic material.

Providing that the low-density plastic material is over-molded onto the beams allows the plastic material to be easily integrated into the interior of the electrical storage battery.

The tolerances for the dimensions of the internal surfaces of each compartment defined by the over-molded plastic material are small and acceptable. These tolerances are essentially the thickness tolerance of the low-density plastic layer sandwiched between the beam and the internal surface of the compartment. This thickness is reduced, and therefore the corresponding tolerance is also reduced.

In addition, because some of the internal surfaces of each compartment are defined by the low-density plastic, these internal surfaces have some flexibility. This facilitates the insertion of the modules, despite the tolerances on the dimensions and on the position of the internal surfaces.

Furthermore, because some of the internal surfaces of each compartment are made by over-molding the low-density plastic onto the beams, it is possible to easily make the fluid circulation channels defined between the electricity storage cells and the low-density plastic. For example, these channels can be made as recessed areas on the surface of the low-density plastic material formed during over-molding.

### BRIEF DESCRIPTIONS OF THE DRAWINGS

FIG. 1 is a perspective view of the electricity storage battery of the present disclosure, the cover shown separated from the lower part of the casing, the electricity storage cells not present and the beams shown before over-molding of the low-density plastic material;

FIG. 2 is a perspective view similar to FIG. 1, with the cover not shown and the low-density plastic over-molded on the beams and on the lower part of the casing;

FIG. 3 is a perspective view of a part of a module of the electrical storage battery of FIG. 1, and the layer of low-density plastic defining the inner surface of the module's receiving compartment;

FIG. 4 is a top view of the subassembly shown in FIG. 2, with the modules shown inserted in the compartments, and the path of the dielectric fluid through the battery symbolically represented by gray lines;

FIG. 5 is a cross-sectional view in a transverse and vertical plane of a part of the battery of FIG. 1;

FIG. 6 is a sectional view in a longitudinal and vertical plane of a part of the battery of FIG. 1; and

FIG. 7 is a perspective view showing the second part of the mold for obtaining the low-density plastic material shown in FIG. 2, as well as the beams and skin for covering the low-density plastic material.

### DETAILED DESCRIPTION

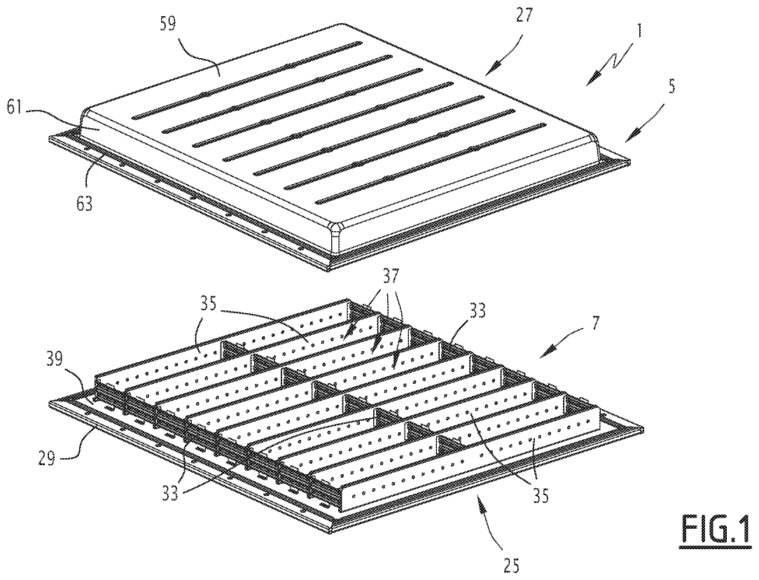

The electric battery shown in FIGS. 1 to 4 is intended to equip a vehicle, typically a motor vehicle such as a car, bus or truck.

The vehicle is a vehicle propelled by an electric motor, for example, the motor being electrically powered by the electric battery. In a variant, the vehicle is a hybrid type and thus comprises an internal combustion engine and an electric motor powered electrically by the electric battery. According to yet another variant, the vehicle is propelled by an internal combustion engine, the electric battery being provided to supply electrically other vehicle equipment, for example the starter, the lights, etc.

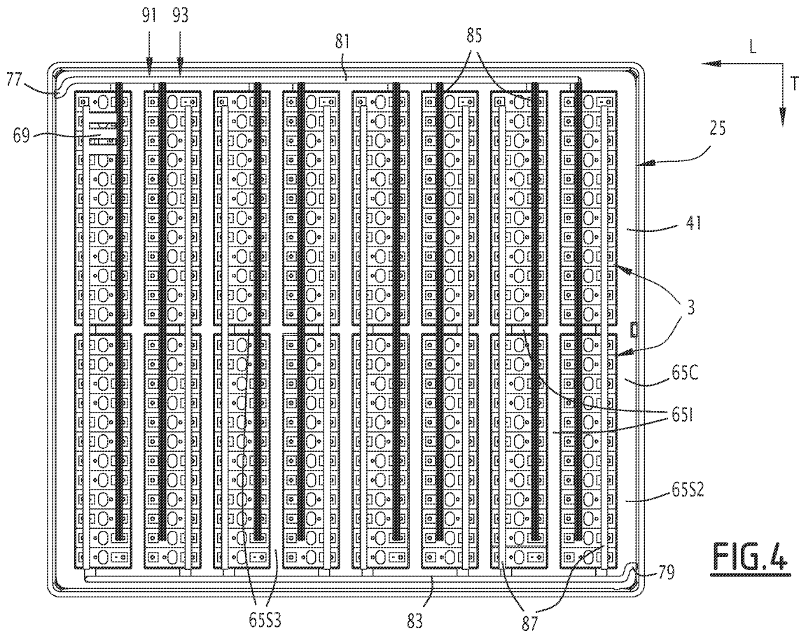

The electricity storage battery 1 comprises a plurality of modules 3 (FIG. 4) and a casing 5 (FIG. 1) which internally delimits a volume 7 for receiving the modules 3.

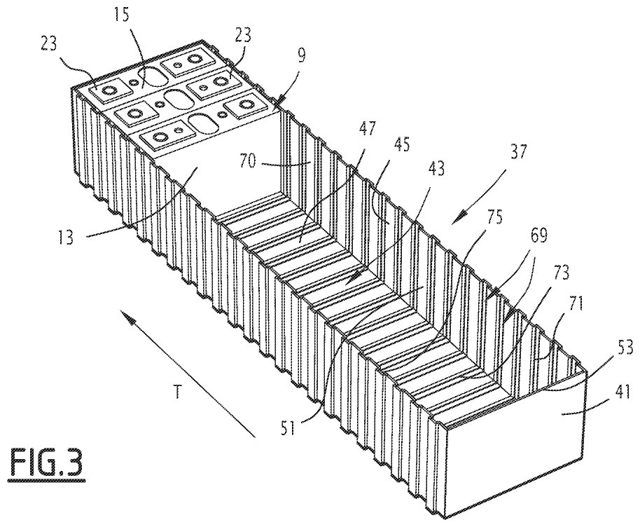

As can be seen in FIGS. 3 and 4, each module 3 comprises a plurality of electricity storage cells 9.

The number of modules 3 is based on the electricity storage capacity of the battery 1. In the example shown, the battery contains sixteen modules 3. However, the battery may contain more than sixteen modules or fewer than sixteen modules.

The electricity storage cells 9 are of any suitable type: Lithium-ion Polymer (Li-Po), Lithium Iron Phosphate (LFP), Lithium Cobalt (LCO), Lithium Manganese (LMO), Nickel Manganese Cobalt (NMC), or NiMH (Nickel Metal Hydride) type cells.

In the example shown in FIG. 4, each module 3 contains twelve cells. However, the number of cells in a single module may be different from twelve: it is either greater than twelve or less than twelve.

Sometimes, each electricity storage cell 9 is prismatic in shape.

It has two large faces 11, 13 and four small faces 15, 17, 19, 21 connecting the two large faces 11, 13 to each other (FIGS. 3, 5 and 6).

The two large faces 11, 13 are parallel and opposite to each other. The four smaller faces 15, 17, 19, 21 are perpendicular to each other and are perpendicular to the larger faces 11, 13.

Each electricity storage cell 9 has two electrical contacts 23.

These electrical contacts 23 are carried by the small face 15.

In a single module 3, the electricity storage cells 9 are juxtaposed transversely. The transverse direction is represented by an arrow T in the Figures.

The cells 9 are in contact with each other through their respective large faces 11, 13.

The small faces 15 carrying the electrical contacts 23 face the same way and are juxtaposed.

The electrical contacts 23 of the different cells of the same module 3 are connected to each other, so as to place the electricity storage cells 9 in series and/or in parallel. The connectors for connecting the electrical contacts 23 of the cells are not shown in the Figures.

Each module 3 therefore has the shape of a parallelepiped block with an elongated shape along the transverse direction T.

As can be seen in FIG. 1, the casing 5 has a lower part 25 and a cover 27. Sometimes, the lower part 25 of the casing faces downward, i.e., toward the running surface in the case of a vehicle battery. The cover 27 faces upward.

In the example shown, the lower part 25 has the shape of a substantially flat plate, constituting a rigid frame supporting the modules 3. In a variant, the lower part has the shape of a tray, or any other suitable shape.

The cover 27 is concave towards the lower part 25.

The lower part 25 and the cover 27 are in tight contact with each other along a peripheral line. In the example shown, the lower part 25 is rectangular, and the contact line is also rectangular.

In the example shown, the lower part 25 and the cover 27 are attached to each other by clamps 29 and screws, not shown.

The clamps 29 here are arranged along each of the four sides of the lower part 25. Each clamp 29 clamps the edge of the lower part 25 with the protruding flange of the cover 27.

The battery 1 further includes beams 33, 35, integral with the casing 5, sometimes the lower part 25 of the casing 5, and dividing the receiving volume 7 into a plurality of compartments 37.

Each module 3 is received in one of the compartments 37.

Preferably, each compartment 37 receives a single module 3.

The beams 33, 35 are sometimes metal sections. The beams 33 are oriented longitudinally, and the beams 35 transversely.

The beams 33, 35 are integral with the lower part 25 of the casing 5. They are fixed on an upper surface 39 of the lower part 25.

They are fixed by any means: welding, screwing, brazing, etc.

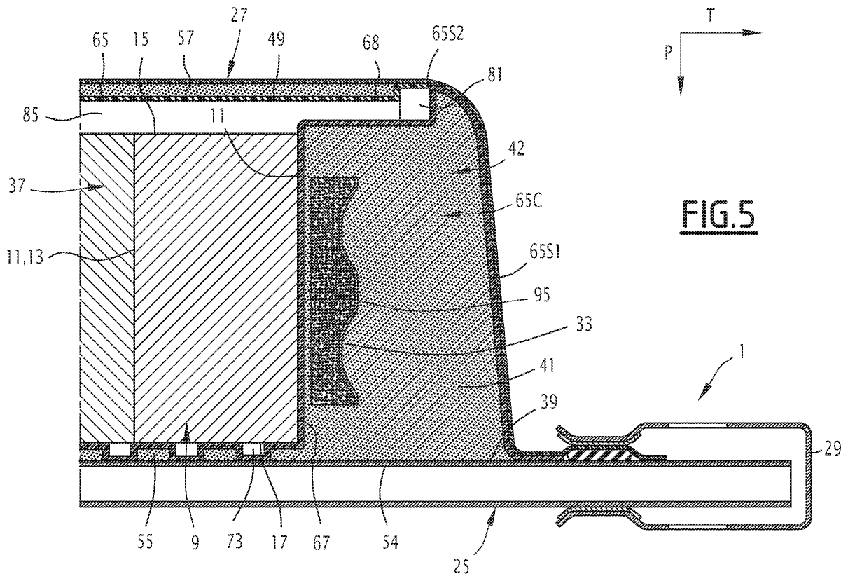

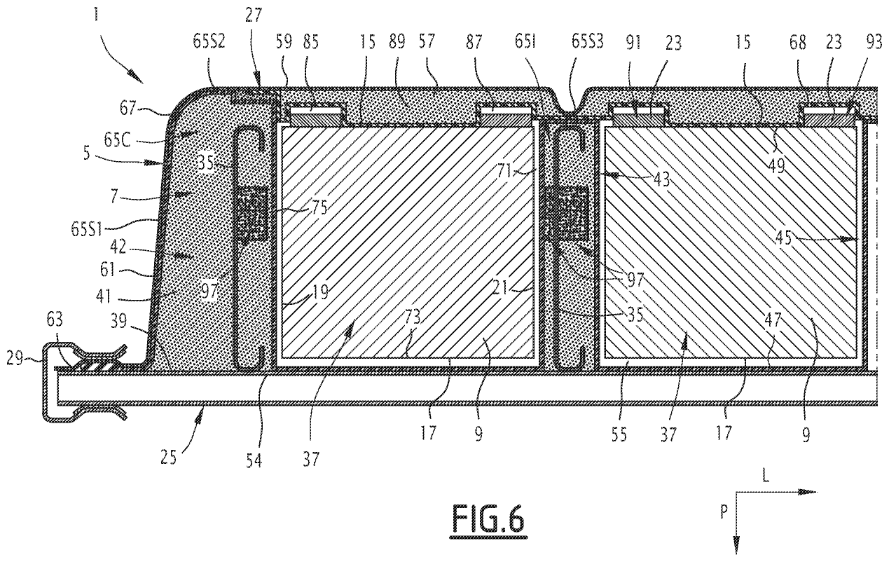

In the example shown, the transverse beams 35 are C-sections, as shown in FIG. 6. The longitudinal beams 33 have corrugated sections (FIG. 5).

Sometimes, each transverse beam 35 extends across the entire transverse width of the casing 5.

Similarly, each longitudinal beam 33 extends along the entire longitudinal length of a compartment 37.

The longitudinal beams 33 connect two consecutive transverse beams 35.

In the example shown, the beams 33, 35 define two longitudinal rows of compartments 37 between them.

The compartments 37 are transversely elongated. Each compartment 37 of the first row is transversely juxtaposed and transversely placed in the extension of a compartment 37 of the second row.

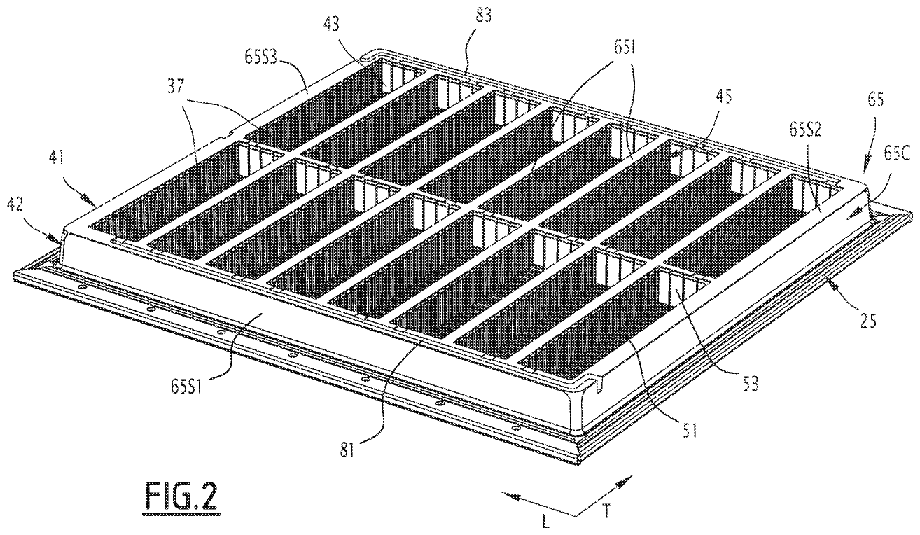

As shown in FIGS. 2, 5 and 6, the battery 1 comprises a low-density plastic material 41, an upper part 42 of which is over-molded onto the beams 33, 35.

A low-density plastic material is a plastic material with a density of less than 0.2 kg per liter.

As such, each compartment 37 is delimited by an inner surface 43 at least partially defined by the upper part 42 of the low-density plastic material 41.

The inner surface 43 of the compartment 37 comprises a closed contour lateral surface 45, a lower surface 47 and an upper surface 49 visible in FIG. 6.

The lateral surface 45 of the inner surface 43 of the compartment 37 is substantially parallel to a main direction, denoted in the Figures by arrows P. This main direction P is substantially perpendicular to the rolling surface when the battery is installed on board the vehicle.

The lower surface 47 constitutes the bottom of the compartment 37. It is turned towards the lower part 25 of the casing 5. It is substantially perpendicular to the main direction P.

The lateral surface 45 has two large surfaces 51 facing each other, lying in planes containing the transverse direction T and the main direction P (FIGS. 2 and 3). It also includes two small surfaces 53 facing each other, lying in respective planes containing the longitudinal L and main P directions (FIGS. 2 and 3).

The lateral surface 45 is sometimes defined by the low-density plastic material 41.

More specifically, it is defined by the upper part 42 of the low-density plastic material 41, over-molded onto the beams 33, 35.

The large surfaces 51 are defined by the low-density plastic material 41 over-molded on the transverse beams 35, and the small surfaces 53 are defined by the low-density plastic material 41 over-molded on the longitudinal beams 33.

The lower part 25 of the casing 5 comprises an area defining a lower bottom 54 of the casing 5. This lower bottom 54 corresponds to the central area of the lower part 25 in the example shown, and supports the modules 3.

The low-density plastic material 41 also comprises a lower part 55 over-molded on the lower bottom 54 of the casing 5.

More specifically, this lower part 55 is over-molded onto the upper surface 39 of the lower part 25.

The lower surface 47 of each compartment 37 is defined by the bottom part 55 of the low-density plastic material 41.

As seen in FIGS. 5 and 6, a block 57 of said low-density plastic material 41 is integral with the cover 27 of the casing 5.

The block 57 is positioned within the cover 27.

As seen in particular in FIG. 1, the cover 27 has an upper end 59, an edge 61 erected around the entire periphery of the upper end 59, extended by an outwardly projecting flange 63 abutting the lower part 25 of the casing 5.

The block 57 covers a central part of the upper end 59.

The block 57 defines the upper surface 49 of each compartment 37 (see FIGS. 5 and 6).

As described below, the block 57 is over-molded into the cover 27 of the casing 5.

In a variant, the block 57 is manufactured by any suitable means, such as by molding, and then secured within the cover 27.

As visible in FIG. 5, the longitudinal beams 33 are completely embedded in the low-density plastic material 41. There are thus layers of low-density plastic material 41 above, below, and transversely on either side of each longitudinal beam 33.

As can be seen in FIG. 6, the transverse beams 35 are also completely embedded in the low-density plastic material 41, except at their lower edges, which are bonded directly to the lower part 25 of the casing 5. There are thus layers of low-density plastic 41 above and longitudinally on either side of each transverse beam 35.

The low-density plastic material 41 thus forms a one-piece mass 65, projecting toward the cover 27 from the bottom 54 of the casing 5.

This mass 65 defines a frame 65C and a plurality of internal partitions 651 within the frame 65C (FIG. 2).

The frame 65C and internal partitions 651 follow the design of the beams 33, 35.

An outer lateral surface 65S1 of the frame 65C is plated against the upstanding edge 61 of the cover 27 of the casing 5 (FIGS. 5 and 6). The upper edge 65S2 of the frame 65C is plated against the upper end 59 of the cover 27 of the casing 5, around the block 57, and also against the periphery of the block 57.

The upper edges 65S3 of the inner partitions 651 abut the free surface of the block 57.

The top edge 65S2 is wider than the top edges 65S3 of the internal partitions 651.

Together, the low-density plastic material 41 and the block 57 occupy at least 70%, preferably at least 80%, more preferably 90% of the free space within the casing 5. “Free space” is understood here as the space that is not occupied by the modules 3 and by any electronic components housed inside the casing 5.

The low-density plastic material 41 can be a foam. The foam sometimes has a density of between 0.050 and 0.15 kilograms per liter, and preferably between 0.07 and 0.13 kilograms per liter.

Sometimes, the foam is a polyurethane foam. In a variant, the foam is a polyurethane/polyurea, poly(EVA), polyethylene, polypropylene foam, or a silicone foam obtained either by reactive means or by gas expansion using steam, for example.

In some embodiments, the foam is a closed cell foam. In a variant, it is an open cell foam.

In any case, the low-density plastic material 41 is covered with a skin 67 of a material that is impermeable to the dielectric fluid cooling the cells of the battery 1.

Such a skin 67 makes it possible to limit absorption of the dielectric fluid by the low-density plastic material 41. This is particularly useful when this low-density plastic material 41 is an open-cell foam. It is also useful for closed cell foams, to a lesser extent.

This skin 67 covers at least those surfaces of the low-density plastic material 41 that are likely to be in contact with the dielectric fluid. Preferably, it covers all of the free surfaces of the low-density plastic material 41.

It covers at least the lateral surface 45 and the lower surface 47 of each compartment 37. It also covers the outer lateral surface 65S1 and the top edge 65S2 of the frame 65C, as well as the top edges 65S3 of the inner partitions 651.

The skin 67 is a layer of epoxy resin (®) or the like, or a layer of acrylic, or polyurea, or polyurethane.

It may be deposited by a casting or spraying process. In a variant, the skin 67 is made of a sheet of plastic material thermoformed to the desired shape. This skin is then made of polystyrene, or polycarbonates, or any other suitable material. This operation is described later.

The skin 67 prevents any direct contact between the dielectric fluid and the low-density plastic material 41.

In addition, the skin 67 is mechanically more resistant to tearing and abrasion than the low-density plastic material 41. When inserting the modules 3 into the compartments 37, the risk of damaging the low-density plastic material 41 is therefore reduced. The long-term performance of the battery 1 is improved.

The skin 67 is made of a material with low resistance to friction. As such, the skin 67 facilitates the insertion of the modules 3 and resists micro-vibrations between the modules 3 and the internal surface 43 of each compartment 37.

The block 57 of low-density plastic material 41 is also covered with a skin 68 of a material that is impervious to the dielectric fluid.

As before, the skin 68 covers at least the surfaces of the block 57 of low-density plastic material 41 likely to be in contact with the dielectric fluid. Preferably, it covers the entire free surface of the block 57 of low-density plastic material 41. It covers at least the upper surface 49 of each compartment 37.

Each compartment 37, unladen, has a first section perpendicular to the main direction P. “Unladen” is understood as the section of the compartment 37 when the module 3 is not housed inside it. This first section is delimited by the lateral surface 45.

The module 3 received in said compartment 37 has a second section perpendicular to the main direction P, greater than the first section.

Sometimes, each module 3 has a longitudinal width greater than that of the corresponding compartment 37. The longitudinal width is taken between the two large surfaces 51 of the lateral surface 45 of the internal surface 43 of the compartment 37.

Similarly, the module 3 has a transversal length greater than the length of the corresponding compartment 37. The length of the compartment is taken between the two small surfaces 53 of the lateral surface 45 of the inner surface 43 of the compartment 37.

For example, the difference in transverse length is between 1 mm and 1.5 mm, and the difference in longitudinal width is between 0.2 mm and 0.5 mm.

As such, the cells 9 are locked in position relative to each other in the corresponding compartment 37 by the pressure exerted by the low-density plastic material 41. In particular, they are pressed against each other in the transverse direction T.

As a result, the cells 9 of each module 3 have to be inserted into the corresponding compartment 37 without any play by means of a specific boxing tool.

Such an arrangement may be advantageous because it is no longer necessary to provide specific means for fixing the cells 9 of a single module 3 to each other. The patent application filed under No. FR1900228, provides for placing the cells between two end flanges, the flanges and the cells being pressed against each other by means of a strap wrapped around the module. The flanges and strap are not useful in the present battery, due to the pressure exerted on the cells 9 by the low-density plastic material 41.

As seen in particular in FIGS. 4 to 7, the cells are arranged so that the small face 15 carrying the electrical contacts 23 of each cell 9 faces the upper end 59 of the cover 27. The small face 17, opposite the small face 15, is pressed against the lower surface 47 of the inner surface 43 of the compartment 37. The small faces 19 and 21 are pressed against the lateral surface 45 of the internal surface 43 of the compartment 37, and more precisely against the two large surfaces 51 of the lateral surface 45.

The large faces 11 and 13 of the two cells 9 located at the transverse ends of the module 3 rest against the small surfaces 53 of the lateral surface 45.

Fluid circulation channels 69 are defined between the electrical storage cells 9 and the low-density plastic material 41.

The circulation channels 69 are provided for the circulation of a dielectric fluid providing cooling for the cells 9.

These circulation channels 69 may be recessed reliefs defined in the low-density plastic material 41.

The battery 1 includes one circulation channel 69 for each cell 9 of each module 3.

The circulation channel 69 extends along the three small faces 17, 19, 21 of the cell 9 that do not carry the electrical contacts 23.

The circulation channel 69 is thus U-shaped, with a first section 71 cut into one of the large surfaces 51 of the lateral surface 45, a second section 73 cut into the lower surface 47, and a third section 75 cut into the other large surface 51 of the lateral surface 45 of the inner surface 43 of the compartment 37.

The circulation channels 69 are open to the cells 9.

The circulation channels 69 serving two adjacent cells 9 are separated from each other by flat fields 70 that abut the small faces 17, 19, 21 of the cells.

When the low-density plastic material 41 includes a skin 67, the surface of each circulation channel 69 is covered by the skin 67.

As seen in FIG. 4, the casing 5 has a dielectric fluid inlet opening 77, and a dielectric fluid outlet port 79.

The battery 1 includes a cooling circuit fluidly connecting the dielectric fluid opening 77 to the dielectric fluid opening 79.

This cooling circuit distributes the dielectric fluid to the various compartments 37 and is arranged so that the dielectric fluid circulates in contact with the electricity storage cells 9.

The circulation channels 69 are part of the cooling circuit.

Typically, the inlet and outlet openings 77, 79 are arranged at two opposite points of the cover 27, for example at two corners of the frame 65C.

In addition, the cooling circuit comprises a dielectric fluid distribution manifold 81 connected to the dielectric fluid inlet 77.

Similarly, the cooling circuit comprises a dielectric fluid discharge manifold 83 connected to the dielectric fluid outlet 79.

As seen in FIGS. 2, 4 and 5, the distribution manifold 81 is at least partially delimited by the low-density plastic material 41. Specifically, it is delimited between the low-density plastic material 41 and the block 57 housed in the cover 27 of the casing 5.

In the illustrated example, the low-density plastic material 51 and the block 57 have respective opposing recessed reliefs, together defining the distribution manifold 81.

In the example shown, the recessed relief of the low-density material 41 is provided along the top edge 65S2 of the frame 65C. The distribution manifold 81 extends along a longitudinal side of the frame 65C.

Similarly, the discharge manifold 83 is at least partially delimited by the low-density plastic material 41. More specifically, the low-density plastic material 41 and the block 57 housed in the cover 27 of the casing 5 delimit the discharge manifold 83 between them.

The low-density plastic material 41 and the block 57 comprise respective opposing recessed reliefs, together delimiting the discharge manifold 83.

In the illustrated example, the recessed relief of the low-density material 41 is provided along the top edge 65S2 of the frame 65C. The discharge manifold 83 extends along another longitudinal side of the frame 65C opposite the distribution manifold 81.

Preferably, the cooling circuit includes a dielectric fluid distribution submanifold 85 provided for each module 3 in block 57 (FIGS. 4, 5, 6).

Similarly, the cooling circuit includes a dielectric fluid discharge sub-manifold 87 provided for each module 3 in block 57.

The distribution sub-manifold 85 fluidly connects the distribution manifold 81 to the circulation channels 69 serving the cells 9 of the corresponding module 3.

The distribution submanifolds 85 are shown schematically in FIG. 4. They can all be seen to be parallel to each other, extending transversely from the distribution manifold 81.

In the example shown, each distribution sub-manifold 85 serves the two modules 3 located transversely in line with each other.

Each distribution submanifold 85 is a recessed relief cut into the free surface of the block 57 (FIG. 6).

The first section 71 of each circulation channel 69 opens into the corresponding distribution sub-manifold 85.

The discharge sub-manifold 87 fluidly connects the discharge manifold 83 to the circulation channels 69 serving the cells 9 of the corresponding module 3.

The evacuation sub-manifolds 87 are schematically shown in FIG. 4. They can all be seen to be parallel to each other, and extend transversely from the evacuation manifold 83.

In the example shown, each evacuation sub-manifold 87 serves the two modules 3 located transversely in line with each other.

Each discharge sub-manifold 87 is a recessed relief cut into the free surface of block 57 (FIG. 6).

The second section 75 of each circulation channel 69 opens into the corresponding discharge sub-manifold 87.

The distribution and discharge sub-manifolds 85, 87 serving the same module 3 extend next to each other. They are separated from each other by a continuous mass 89 formed in the free surface of the block 57, resting on the small face 15 of the cells carrying the electrical contacts 23.

The electrical contacts 23 of the cells of the same module 3 are arranged in two transverse lines 91, 93. The electrical contacts 23 of the transverse line 91 are engaged in the distribution sub-manifold 85, and those of the transverse line 93 in the discharge sub-manifold 87.

The arrangement described above for the manifolds and sub-manifolds ensures that the path of the dielectric fluid from the inlet to the outlet is always the same length, regardless of which distribution sub-manifold, circulation channel, and discharge sub-manifold it passes through. The pressure drops are also practically the same. The temperature homogeneity inside the battery 1 is very good, the temperature gradients being very limited.

It should be noted that the surfaces defining the distribution manifolds 81 and evacuation manifolds 83 and the distribution and evacuation sub-manifolds 85, 87 are covered by the skins 67 and 68.

It should also be noted that the block 57 is in contact with the low-density plastic material 41 over its entire free surface, with the exception of the areas located in front of the compartments 37, the areas located in front of the distribution and evacuation manifolds 81, 83 and the areas located in front of the distribution and evacuation sub-manifolds 85, 87. This creates a level of sealing between the distribution and discharge manifolds 81, 83.

The low-density plastic material 41 has good mechanical properties. In the case of a polyurethane foam with a density of 100 grams per liter, the pressure required to press a block of 60 mm×60 mm×60 mm, 6% of its height, is 586 N, i.e. a pressure of 165 kPa.

In contrast, it has a moderate resilience. Resilience is the ability of a material to return to its initial position at the same speed as when it was deformed. For example, for a semi-rigid polyurethane foam of the type used to make the low-density plastic material 41, the resilience is between 15 and 30%. The compressive strength at 40% deformation is greater than 200 kPa.

As shown in FIGS. 5 and 6, inserts 95, 97 of an elastic material are interposed between the inner surface 43 of the compartments 37 and the beams 33, 35.

This resilient material has a second resilience, greater than the first resilience.

Typically, the inserts 95 are positioned between the longitudinal beams 33 and the lateral surface 45 of each compartment 37, more specifically between the longitudinal beams 33 and the small surfaces 53 of the lateral surface 45.

Similarly, the inserts 97 are interposed between the transverse beams 35 and the lateral surface 45 of each compartment 37, more precisely between the transverse beams 35 and the large surfaces 51 of the lateral surface 45.

The inserts 95, 97 are made of a high density expanded foam, for example a polyamide or polypropylene or polyurethane of 120 to 200 grams per liter.

A high density expanded foam is a foam having a density greater than 100 grams per liter.

The inserts 95, 97 are put in position by being glued to the beams 33, 35, prior to over-molding the low-density plastic material 41, for example.

The inserts 95, 97 may offer advantages.

The pressure in the cells 9 varies according to the alternation of electrical charges and discharges. This pressure will affect the geometry of the cells 9, especially at the large faces 11 and 13 of the electricity storage cells 9. The cumulative swelling of all the cells 9 of a single module 3 along the transverse direction T can create a stress, at the small surfaces 53 of the lateral surface 45, of up to 500 kilos. The inserts 95 placed along the longitudinal beams 33 make it possible to absorb this force without damage. Without these inserts 95, the low-density plastic material 41 placed there, which is less resilient, could eventually be damaged.

These inserts 95 also make it possible to take up transverse accelerations experienced by the modules 3 and which create a significant pressure on the small surfaces 53 of the lateral surface 45. These accelerations may result from the normal movement of the vehicle or from impacts.

The inserts 97, placed along the large surfaces 51 of the lateral surface 45, also make it possible to take up the longitudinal accelerations undergone by the modules 3. These longitudinal accelerations result from the normal movement of the vehicle (acceleration and braking) or from shocks.

In addition, due to their high resilience, the inserts 95, 97, facilitate the insertion of the modules 3 into the compartments 37.

The inserts 95 preferably extend across the entire longitudinal width of each compartment 37. Similarly, the inserts 97 preferably extend along the entire transverse length of each compartment 37.

The method for manufacturing the above electrical storage battery 1 will now be described.

This method comprises the following steps:
obtaining a first mold side 99 comprising the lower part 25 of the casing 5 and the beams 33, 35, assembled at the lower part 25 of the casing 5;
obtaining a second mold side 101 comprising negative imprints 103 of the compartments 37;
forming a mold using the first and second mold sides 99, 101, the second mold side 101 being positioned relative to the first mold side 99 such that the negative indentations 103 of the compartments 37 are engaged between the beams 33, 35 of the first mold side 99, the first and second mold sides 99, 101 defining a molding cavity between them (not shown);
introducing a liquid into the mold cavity and forming said low-density plastic material 41 from the liquid.

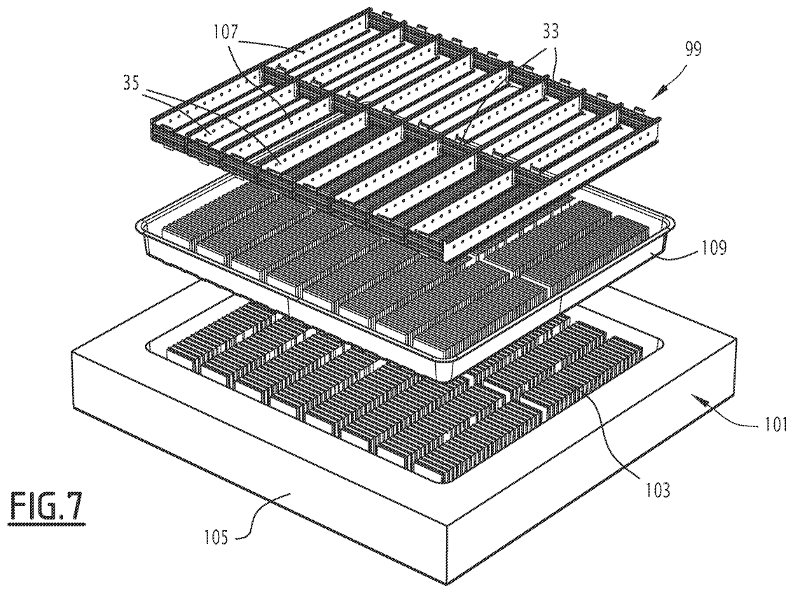

In FIG. 7, the first mold side 99 is not fully shown. The lower part 25 of the casing 5 has been omitted. Only the beams 33, 35 are shown.

In contrast, the second mold side 101 is visible in FIG. 7 and includes a frame 105, surrounding the negative indentations 103 of the compartments 37.

Each compartment 37 has a hollow shape. The negative cavity 103 of the compartment 37 is a solid form exactly matching the hollow shape of the compartment 37.

The negative indentation 103 exactly fits into the corresponding compartment 37.

The negative indentation 103 exactly draws all of the relief of the lateral surface 45 of the compartment 37 and the interior surface 47 of the compartment 37.

In particular, the negative indentation 103 draws the various circulation channels 69 as projections.

It should be noted that the second mold side 101 also includes negative imprints of the distribution and evacuation manifolds 81, 83.

After the mold has been formed, the mold cavity has a shape that corresponds exactly to that of the low-density plastic material 41.

When the low-density plastic material 41 is a foam, the liquid introduced into the mold cavity is a mixture of reaction liquids leading to the formation of the foam. Typically, the reaction leading to the formation of the foam takes between three and ten minutes.

The low-density plastic material 41 naturally adheres to the lower part 25 of the casing 5 and to the beams 33, 35.

When the low-density plastic material 41 is not coated with a skin 67, a release agent is applied to the second mold side 101 to prevent adhesion of the low-density plastic material 41 to the second mold side 101.

It should be noted that it is necessary to provide a vent in the upper part of the mold so that the air contained in the cavity, as well as gases such as CO2 produced during the foaming reaction, are evacuated.

In the case of foaming, as the foam forms in the mold cavity, the level of the liquid increases. This liquid must be distributed evenly throughout the mold cavity to avoid creating a foam-free zone where the air and gases produced during the reaction would be trapped.

To facilitate this distribution, the longitudinal beams 33 and the transverse beams 35 have holes 107 to allow gases to circulate between the compartments 37 and into the vents. This allows the liquid level to be homogenized as it rises. These holes 107 can be placed at different heights and locations depending on the chemical nature of the liquid, the number of introduction points, and the complexity of the geometry.

The block 57 of low-density plastic material 41 is obtained by a similar method. The battery manufacturing method then includes the following steps:
obtaining a third mold side comprising the cover 27 of the casing 5;
obtaining a fourth mold side comprising at least the negative imprints of the distribution and/or evacuation sub-manifolds 85, 87;
forming a mold using the third and fourth mold sides, the third and fourth mold sides defining a further mold cavity between them;
introducing a liquid into the other mold cavity and forming the block 57 of low-density plastic material 41 from the liquid.

Typically, the fourth mold side includes not only the negative indentations of the submanifolds 85, 87 but also the negative indentations of the parts of the distribution and discharge manifolds 81, 83 that are provided in the block 57.

The introduction of the liquid and the formation of the low-density plastic material 41 from the liquid are performed as described above.

In the case where the low-density plastic material 41 is coated with a skin 67, the manufacturing method comprises a step of placing the skin 67 on the low-density plastic material 41, performed after the step of introducing the liquid into the molding cavity and forming the low-density plastic material 41 from the liquid.

In other words, the skin 67 is made after the foam is formed. The skin 67 is typically poured or sprayed onto the low-density plastic material 41 using known processes that will not be described here.

In a variant, the skin 67 is obtained by thermoforming.

In this case, the manufacturing method comprises a step of thermoforming a plate of said material tight vis-a-vis the dielectric fluid against the second mold side 101.

In particular, the thermoforming is performed against the negative indentations 103 of the compartments 37.

This thermoforming step is performed prior to the step of introducing the liquid into the mold cavity and forming the low-density plastic material 41 from the liquid.

The second mold side 101 is arranged to make thermoforming possible. Typically, it is equipped with means for heating the plate and with openings for applying a vacuum to press the plate to be thermoformed against the inner surface of the second mold side 101. Such a method is known and will not be described in detail here.

In this case, in the introduction step, liquid is introduced between the thermoformed plate 109 (visible in FIG. 7) and the first mold side 99.

Due to the presence of the skin 67, there is generally no need for a release fluid.

The skin 68 of the insert can be obtained in the same manner as the skin 67.

According to a third aspect, the present disclosure relates to a vehicle equipped with the electricity storage battery 1 described above.

The vehicle comprises a circuit for cooling the dielectric fluid, fluidly connected to the dielectric fluid inlet and outlet openings 77, 79.

The circuit includes at least one device for circulating the dielectric fluid along the circuit and a heat exchanger arranged to cool the dielectric fluid circulating in the circuit.

The circulation device is a pump, for example. The heat exchanger is an air heat exchanger, or any other suitable type of heat exchanger.

The dielectric fluid is a coolant, for example, fluorinated or not, or a mineral oil, or a modified vegetable oil.

Electricity storage cells can be cooled by immersing them in a dielectric liquid.

The use of a dielectric liquid allows direct cooling of the live parts without interfering with the operation of these parts, as the electrical conductivity of the liquid can be considered as zero. This type of cooling is very efficient and allows good density exchanges to be obtained. It also allows large surfaces to be cooled.

Indirect contact cooling systems, by comparison, do not generally allow the entire surface of the heat-emitting part to be cooled. In such a system, usually only the most accessible part is cooled. This inevitably leads to undesired temperature gradients.

In particular, in the case of cooling by air circulation, the heat exchange density is very low, even if convection is forced by ventilation.

Cooling by a dielectric liquid can have the disadvantage of being costly, especially as the price of the dielectric liquid is high.

In order to reduce the volume of dielectric liquid used, it is possible to provide parts made of a low-density plastic material inside the battery. These parts can be shaped so as to delimit a circulation path for the dielectric liquid, making it possible to cool the largest possible part of each of the cells placed inside the battery.
according to a first aspect, the present disclosure relates to an electricity storage battery, the battery comprising:
a plurality of modules, each module comprising a plurality of electricity storage cells;
a casing internally delimiting a volume for receiving the modules, the casing comprising a lower part and a cover
beams integral with the casing and dividing the receiving volume into a plurality of compartments, each module being received in one of the compartments;
a low-density plastic material comprising an upper part over-molded on the beams, each compartment being delimited by an internal surface at least partially defined by the upper part of the low-density plastic material.

Providing that the low-density plastic material is over-molded onto the beams allows the plastic material to be easily integrated into the interior of the electrical storage battery.

The tolerances for the dimensions of the internal surfaces of each compartment defined by the over-molded plastic material are small and acceptable. These tolerances are essentially the thickness tolerance of the low-density plastic layer sandwiched between the beam and the internal surface of the compartment. This thickness is reduced, and therefore the corresponding tolerance is also reduced.

Another possibility for making the low-density plastic parts would be to make these parts by cutting or molding, and to place them against the beams. According to this embodiment, the low-density plastic parts are not over-molded onto the beams. As a result, the tolerances on the positions of the internal surfaces of each compartment are much higher. This is because the manufacturing and assembly tolerances of the beams in the shell and the manufacturing tolerances of the low-density plastic parts are added together. In total, the tolerances are much higher than in the present disclosure.

In addition, because some of the internal surfaces of each compartment are defined by the low-density plastic, these internal surfaces have some flexibility. This facilitates the insertion of the modules, despite the tolerances on the dimensions and on the position of the internal surfaces.

Furthermore, because some of the internal surfaces of each compartment are made by over-molding the low-density plastic onto the beams, it is possible to easily make the fluid circulation channels defined between the electricity storage cells and the low-density plastic. For example, these channels can be made as recessed areas on the surface of the low-density plastic material formed during over-molding.

The electrical storage battery may further have one or more of the following features, considered individually or in any technically possible combination:
the low-density plastic material is a foam;
the inner surface of each compartment comprises a lateral surface with a closed contour, substantially parallel to a main direction, defined by the upper part of the low-density plastic material, said compartment, when empty, having a first section perpendicular to the main direction, the module received in said compartment having, perpendicular to the main direction, a second section greater than the first section;
the lower part comprises an area defining a lower bottom of the casing, the low-density plastic material comprising a lower part over-molded on the lower bottom, the inner surface of each compartment comprising a lower surface delimiting the compartment towards the lower bottom and defined by the lower part of the low-density plastic material;
the low-density plastic material has a first resiliency with inserts of a resilient material interposed between the inner surface of the compartments and the beams, the resilient material having a second resiliency greater than the first resiliency;
the battery comprises a cooling circuit containing fluid circulation channels defined between the electrical storage cells and the low-density plastic, a dielectric fluid filling the circulation channels;
the low-density plastic is covered with a skin, of a material that is impermeable to the dielectric fluid;
each electricity storage cell is prismatic in shape and has two large faces and four small faces connecting the two large faces to each other, one of the small faces carrying two electrical contacts, each circulation channel being a recessed relief made in the low-density plastic material and extending along the three other small faces;
the casing has a dielectric fluid inlet and a dielectric fluid outlet, the cooling circuit comprising a dielectric fluid distribution manifold, fluidly connected to the dielectric fluid inlet and being at least partially delimited by the low-density plastic material and/or the cooling circuit comprising a dielectric fluid discharge manifold, fluidly connected to the dielectric fluid outlet and being at least partially delimited by the low-density plastic material
a block of said low-density plastic material is integral with the cover, said block delimiting the dielectric fluid distribution manifold and/or the dielectric fluid discharge manifold;
the cooling circuit includes a dielectric fluid distribution sub-manifold provided for each module in the block, said distribution sub-manifold fluidly connecting the distribution manifold to the circulation channels serving the electricity storage cells of said module, and/or the cooling circuit includes a dielectric fluid evacuation sub-manifold provided for each module in the block, said evacuation sub-manifold fluidly connecting the circulation channels serving the electricity storage cells of said module to the evacuation manifold

According to a second aspect, the present disclosure relates to a method for manufacturing an electricity storage battery having the above features, the method comprising the following steps:
obtaining a first mold side comprising the lower part of the casing and the beams assembled to the lower part;
obtaining a second mold side containing negative imprints of the compartments;
forming a mold using the first and second mold sides, the second mold side being positioned relative to the first mold side such that the negative imprints of the compartments are engaged between the beams of the first mold side, the first and second mold sides defining a mold cavity between them;
introducing a liquid into the mold cavity and forming said low-density plastic from the liquid.

The manufacturing method may further comprise one or more of the following features, considered individually or in any technically feasible combination:
the method comprises the following steps:
   obtaining a third mold side comprising the shell cover;
   obtaining a fourth mold side comprising at least negative imprints of the distribution and/or evacuation sub-manifolds;
   forming a mold using the third and fourth mold sides, the third and fourth mold sides defining a further mold cavity between them;
   introducing a liquid into the other mold cavity and forming the low-density plastic block from the liquid;
the method comprises a step of depositing the skin on the low-density plastic material, performed after the step of introducing a liquid into the molding cavity and forming said low-density plastic material from the liquid;
the method comprises a step of thermoforming a plate of said tight material vis-a-vis the dielectric fluid against the negative indentations of the compartments, performed before the step of introducing a liquid into the molding cavity and forming said low-density plastic from the liquid.

According to a third aspect, the present disclosure relates to a vehicle equipped with an electrical storage battery having the above features.

The vehicle comprises a dielectric fluid cooling circuit fluidly connected to the dielectric fluid inlet and outlet openings, the circuit including at least one member for circulating the dielectric fluid along the circuit and a heat exchanger arranged to cool the dielectric fluid circulating in the circuit.

The present disclosure has been described for a battery cooled by a dielectric fluid in direct contact with the electricity storage cells. However, it is applicable to the case of batteries whose electrical storage cells are cooled by indirect heat exchange. The low-density plastic material is provided in this case to obtain certain internal surfaces of the compartments, in order to hold the modules and to dampen the accelerations undergone by these modules. The cooling in this case can be done through the bottom of the casing.

1. A battery for storing electricity, the battery comprising:
a plurality of modules, each module comprising a plurality of electricity storage cells;
a casing internally delimiting a volume for receiving the modules, the casing comprising a lower part and a cover
beams integral with the casing and dividing the reception volume into a plurality of compartments, each module being received in one of the compartments; and
a low-density plastic material comprising an upper part over-molded on the beams, each compartment being delimited by an internal surface at least partially defined by the upper part of the low-density plastic material .

2. The battery according to claim 1, wherein the low-density plastic is a foam.

3. The battery according to claim 1, wherein the inner surface of each compartment comprises a closed-contour lateral surface, substantially parallel to a main direction, defined by the upper part of the low-density plastic material, said compartment having a first section perpendicular to the main direction when empty, the module received in said compartment having a second section greater than the first section, perpendicular to the main direction.

4. The battery according to claim 1, wherein the lower part comprises an area defining a lower bottom of the casing, the low-density plastic material comprising a lower part over-molded on the lower bottom, the inner surface of each compartment comprising a lower surface delimiting the compartment towards the lower bottom and defined by the lower part of the low-density plastic material.

5. The battery according to claim 1, wherein the low-density plastic material has a first resiliency, with inserts of a resilient material interposed between the inner surface of the compartments and the beams, the resilient material having a second resiliency higher than the first resiliency.

6. The battery according to claim 1, wherein fluid circulation channels are defined between the electrical storage cells and the low-density plastic material, a dielectric fluid filling the circulation channels.

7. The battery according to claim 6, wherein the low-density plastic is covered with a skin of a material tight vis-a-vis the dielectric fluid.

8. The battery according to claim 6, wherein each electrical storage cell is prismatic in shape and has two large faces and four small faces connecting the two large faces to each other, one of the small faces carrying two electrical contacts, each circulation channel being a recessed relief in the low-density plastic and extending along the other three small faces.

9. A battery according to claim 1, wherein the casing has a dielectric fluid inlet and a dielectric fluid outlet, the battery including a cooling circuit fluidly connecting the dielectric fluid inlet to the dielectric fluid outlet, this cooling circuit being configured to distribute the dielectric fluid to the various compartments and being arranged so that the dielectric fluid flows in contact with the electricity storage cells.

10. The battery according to claim 9, wherein the cooling circuit includes a dielectric fluid distribution manifold fluidly connected to the dielectric fluid inlet port and being at least partially delimited by the low-density plastic material and/or the cooling circuit including a dielectric fluid discharge manifold fluidly connected to the dielectric fluid outlet port and being at least partially delimited by the low-density plastic material.

11. The battery according to claim 10, wherein a block of said low-density plastic is integral with the cover, said block delimiting the dielectric fluid distribution manifold and/or the dielectric fluid discharge manifold.

12. The battery according to claim 11, wherein fluid circulation channels are defined between the electrical storage cells and the low-density plastic material, a dielectric fluid filling the circulation channels, and wherein the cooling circuit includes a dielectric fluid distribution sub-manifold provided for each module in the block, said distribution sub-manifold fluidly connecting the distribution manifold to the circulation channels serving the electricity storage cells of said module, and/or the cooling circuit includes a dielectric fluid drain submanifold provided for each module in the block said drain sub-manifold fluidly connecting the circulation channels serving the electricity storage cells of said module to the drain manifold.

13. A method for manufacturing an electricity storage battery according to claim 1, the method comprising the following steps:
obtaining a first mold side comprising the lower part of the casing (5) and the beams assembled to the lower part;
obtaining a second mold side comprising negative imprints of the compartments;
forming a mold using the first and second mold sides, the second mold side being positioned relative to the first mold side such that the negative imprints of the compartments are engaged between the beams of the first mold side, the first and second mold sides defining a mold cavity between them; and
introducing a liquid into the mold cavity and forming said low-density plastic material from the liquid.

14. The manufacturing method according to claim 13, wherein
the casing has a dielectric fluid inlet and a dielectric fluid outlet, the battery including a cooling circuit fluidly connecting the dielectric fluid inlet to the dielectric fluid outlet, this cooling circuit being configured to distribute the dielectric fluid to the various compartments and being arranged so that the dielectric fluid flows in contact with the electricity storage cells ;
the cooling circuit includes a dielectric fluid distribution manifold fluidly connected to the dielectric fluid inlet port and being at least partially delimited by the low-density plastic material and/or the cooling circuit including a dielectric fluid discharge manifold connected to the dielectric fluid outlet port and being at least partially delimited by the low-density plastic material;
a block of said low-density plastic is integral with the cover, said block delimiting the dielectric fluid distribution manifold and/or the dielectric fluid discharge manifold;
and the method comprises the following steps:
obtaining a third mold side comprising the cover of the casing;
obtaining a fourth mold side comprising at least negative imprints of the distribution and/or evacuation sub-manifolds;
forming a mold using the third and fourth mold sides, the third and fourth mold sides defining a further mold cavity between them
introducing a liquid into the other mold cavity and forming the block of low-density plastic from the liquid.

15. The manufacturing method according to claim 13,
wherein fluid circulation channels are defined between the electrical storage cells and the low-density plastic material, a dielectric fluid filling the circulation channels ;
wherein the low-density plastic is covered with a skin of a material tight vis-a-vis the dielectric fluid;
the method comprising a step of depositing the skin on the low-density plastic material, performed after the step of introducing into the molding cavity a liquid and forming said low-density plastic material from the liquid.

16. The manufacturing method according to claim 13,
wherein fluid circulation channels are defined between the electrical storage cells and the low-density plastic material, a dielectric fluid filling the circulation channels;
wherein the low-density plastic is covered with a skin of a material tight vis-a-vis the dielectric fluid;
the method comprising a step of thermoforming a plate of said material tight vis-a-vis the dielectric fluid against the negative imprints of the compartments, carried out prior to the step of introducing into the molding cavity a liquid and forming said low-density plastic material from the liquid.
